(19) United States
(12) Patent Application Publication
(10) Pub. No.: US 2016/0283305 A1
(43) Pub. Date: Sep. 29, 2016

(54) INPUT/OUTPUT CONTROL DEVICE, INFORMATION PROCESSING APPARATUS, AND CONTROL METHOD OF THE INPUT/OUTPUT CONTROL DEVICE

(71) Applicant: FUJITSU LIMITED, Kawasaki-shi (JP)

(72) Inventor: Kouji KUGATA, Kawasaki (JP)

(73) Assignee: FUJITSU LIMITED, Kawasaki-shi (JP)

(21) Appl. No.: 15/002,460

(22) Filed: Jan. 21, 2016

(30) Foreign Application Priority Data
Mar. 27, 2015 (JP) 2015-066681

(51) Int. Cl. G06F 11/07; G06F 13/36; G06F 13/40

(52) U.S. Cl. CPC G06F 11/079; G06F 13/4022; G06F 13/36; G06F 11/0745; G06F 11/0751; G06F 11/0772

(57) ABSTRACT

A PCIe processing unit is connected to a PCI device. A BDF information extracting unit specifies, in response to an occurrence notification of an error, a PCI device in which the error has occurred. An AER address searching unit detects the AER address that is the storage location of error information related to the error held by the PCI device specified by the BDF information extracting unit. An error information acquiring unit collects error information from the AER address that is stored in the PCI device and that is detected by the AER address searching unit. An interrupt determination unit transmits the error information collected by the error information acquiring unit to a core.

### CROSS-REFERENCE TO RELATED APPLICATION

This application is based upon and claims the benefit of priority of the prior Japanese Patent Application No. 2015-066681, filed on Mar. 27, 2015, the entire contents of which are incorporated herein by reference.

### FIELD

The embodiments discussed herein are related to an input/output control device, an information processing apparatus, and a control method of the input/output control device.

### BACKGROUND

In order to install expansion cards that are used to expand functions in information processing apparatuses, such as servers, client personal computers (PC), or the like, information processing apparatuses provided with Peripheral Component Interconnect (PCI) Express (hereinafter, referred to as “PCIe”) buses are widely used. In the communication using PCIe buses, errors may sometimes occur due to failures or degradation of hardware. As a mechanism of detecting such errors, there are PCI devices supporting a function called AER (Advanced Error Reporting).

When a PCI device detects an error defined by AER, the PCI device records an error factor in an AER register that is mounted on the PCI device. Furthermore, at the same time as the PCI device records the error factor in the AER register, the PCI device issues a packet called a Message and sends the Message to an operating system (OS) running on a central processing unit (CPU) via a PCIe bus, whereby the PCI device notifies the OS that the error has occurred.

When the OS receives the Message, the OS reads, via the PCIe bus, the information stored in the AER register in the PCI device that has sent the Message. Then, after determining the operation for each error factor, the OS completes the error process.

Furthermore, as a technology related to PCIe, there is a conventional technology that counts errors and send a notification to an operator when the number of times an error occurs becomes equal to or greater than a predetermined number of times.

Patent Document 1: Japanese Laid-open Patent Publication No. 2009-140246

However, a plurality of PCIe devices is usually connected to a PCIe bus. Thus, if errors simultaneously occur in the plurality of PCI devices or if a plurality of errors occurs in a single PCI device in a short period of time, the OS needs to process a large amount of interrupts. Consequently, a large load is applied to the OS due to the process of the interrupts. Furthermore, if the load is applied to the OS, the performance of the job operated in the OS may possibly be degraded.

Furthermore, even if the conventional technology that sends a notification in accordance with the number of times an error occurs is used, it is possible to identify the degradation of the performance due to the occurrence of an error; however, it is difficult to reduce the degradation of the performance itself due to an interrupt.

### SUMMARY

According to an aspect of an embodiment, an input/output control device connects to a processing unit. the input/output control device includes: a specifying unit that specifies, in response to an occurrence notification of an error, a processing unit in which the error has occurred; a detecting unit that detects a storage location of error information related to the error held by the processing unit specified by the specifying unit; a collecting unit that collects the error information from the storage location that is stored in the processing unit and that is detected by the detecting unit; and a transmission unit that transmits the error information collected by the collecting unit to an arithmetic processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating, in outline, a PCIe bus in an information processing apparatus;

FIG. 2 is a schematic diagram illustrating, in outline, an operation of an error processing unit according to a first embodiment;

FIG. 3 is a block diagram illustrating, in detail, the error processing unit according to the first embodiment;

FIG. 4 is a schematic diagram illustrating a search method of an AER address;

FIG. 5 is a flowchart illustrating the flow of a notification process of error information performed by the error processing unit according to the first embodiment;

FIG. 6 is a block diagram illustrating, in detail, an error processing unit according to a second embodiment;

FIG. 7 is a flowchart illustrating the flow of a notification process of the error information performed by the error processing unit according to the second embodiment;

FIG. 8 is a schematic diagram illustrating, in outline, an operation of an error processing unit according to a third embodiment;

FIG. 9 is a block diagram illustrating, in detail, the error processing unit according to the third embodiment; and

FIG. 10 is a schematic diagram illustrating a process of registering and acquiring an AER address with respect to an AER address table.

### DESCRIPTION OF EMBODIMENTS

Preferred embodiments of the present invention will be explained with reference to accompanying drawings. Furthermore, the input/output control device, the information processing apparatus, and the control method of the input/output control device is not limited to the embodiments described below.

### [a] First Embodiment

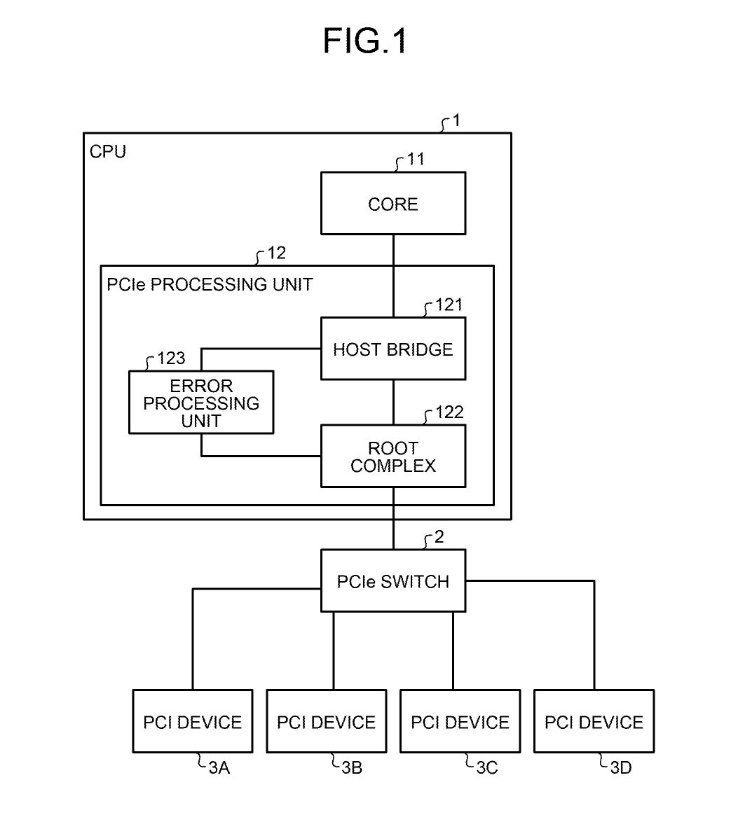

FIG. 1 is a schematic diagram illustrating, in outline, a PCIe bus in an information processing apparatus. As illustrated in FIG. 1, the information processing apparatus that includes a PCIe bus includes a CPU 1, a PCIe switch 2, and PCI devices 3A to 3D. Here, in FIG. 1, four PCI devices, i.e., the PCI devices 3A to 3D, are illustrated; however, the number of PCI devices mounted in the information processing apparatus is not particularly limited. In a description below, when the PCI devices 3A to 3D are not distinguished, the PCI devices will be referred to as a “PCI device 3”.

The CPU 1 is connected to the PCIe switch 2 via a bus. Furthermore, the PCIe switch 2 is connected to the PCI devices 3A to 3D.

The PCIe switch 2 is a device that is used to connect the plurality of PCI devices 3 to a root complex 122. The PCIe switch 2 includes a port for connecting to the root complex 122. Furthermore, the PCIe switch 2 includes a port for connecting the PCI device 3. In this way, in practice, the CPU 1 and the PCI device 3 send and receive data and instruction via the PCIe switch 2; however, to simplify a description, in a description below, a description will sometimes be given as if the CPU 1 and the PCI devices 3 directly send and receive data and an instruction.

The PCI device 3 is a device conforming to the PCIe standard. The PCI device 3 is, for example, a serial advanced technology attachment (SATA) controller or an Ethernet (registered trademark) controller. For example, a hard disk, a solid state drive (SSD), an optical drive, or the like is connected to the SATA controller. Furthermore, the Ethernet controller is a device that is used to connect to a network.

In response to an instruction received from a core 11, the PCI device 3 performs a process in accordance with the received instruction. Then, the PCI device 3 sends back a response to the instruction to the core 11. Furthermore, the PCI device 3 performs data transfer between a memory (not illustrated) by using a direct memory access (DMA). If an error occurs, the PCI device 3 sends a Message to the root complex 122.

Furthermore, the PCI device 3 includes PCI configuration space that is a register in which the information that is used to control the PCI device 3 is stored. An AER register in which error information is stored is included in the PCI configuration space. The error information mentioned here is information indicating the content of a failure, such as an error factor or the like. In a description below, the address of the PCI configuration space in the AER register is referred to as an “AER address”. Furthermore, the AER register mentioned here corresponds to an example of a “storing unit”.

When an error occurs, the PCI device 3 stores, in the AER register, error information related to the error that has occurred. For example, if the link of the PCIe bus connected to the port is disconnected, the PCI device 3 records a “Surprise Down Error” in the AER register. The PCI device 3 mentioned here corresponds to an example of a “processing unit”.

The CPU 1 includes the core 11 and a PCIe processing unit 12. The core 11 is an arithmetic processing device. The core 11 is connected to the root complex 122 via a host bridge 121. When a power supply of the information processing apparatus is turned on, the core 11 receives, from the host bridge 121, an input of the information on the PCI device 3 that is connected to the PCIe switch 2. Then, the core 11 creates device location information on each of the PCI devices 3.

The device location information mentioned here is information indicating the location of the PCI device 3 with respect to the core 11 via the PCIe switch 2 and, in other words, information indicating the location of each of the PCI devices 3 in the device tree with the root complex 122 at the top. Specifically, the device location information is represented by a bus number, a device number, and a function number. In a description below, the device location information may sometimes be referred to as a “BDF (registered trademark)” by using the initial letter of each of the numbers included in the device location information. The core 11 initializes the PCI device 3 that is connected to the PCIe switch 2.

Furthermore, the core 11 sends an instruction to the PCI device 3 via the host bridge 121, the root complex 122, and the PCIe switch 2 and receives a response from the PCI device 3.

The PCIe processing unit 12 is an input/output control device. The PCIe processing unit 12 includes the host bridge 121, the root complex 122, and an error processing unit 123. The PCIe processing unit 12 is implemented by, for example, a large scale integration (LSI) device.

The host bridge 121 is connected to the core 11 and the root complex 122 via the bus. The host bridge 121 is a device that converts a protocol of an instruction sent from the core 11. Specifically, the host bridge 121 sends, to the root complex 122, information that is used to transfer the instruction sent from the core 11 in accordance with the specification prescription of PCIe and sends the instruction to the target PCI device 3 via the PCIe bus. Furthermore, the host bridge 121 sends a packet acquired from the error processing unit 123 to the core 11 together with an interrupt instruction.

The root complex 122 is connected to the core 11 via the error processing unit 123 and the host bridge 121. Furthermore, the root complex 122 is connected to the PCI device 3 via the PCIe switch 2. The root complex 122 is a device that creates a packet that is sent to the PCI device 3 on the basis of the information received from the host bridge 121.

Specifically, the root complex 122 creates, from the instruction sent from the core 11, a packet conforming to the PCIe standard in accordance with the setting received from the host bridge 121. Then, the root complex 122 sends the created packet to the PCI device 3 via the PCIe switch 2. Furthermore, the root complex 122 converts the data sent from the PCI device 3 to a protocol that is associated with the system bus connected to the core 11 and then sends the data to the host bridge 121.

Namely, the path from the core 11 to the root complex 122 is connected by the system bus. In contrast, the path from the root complex 122 to the PCI device 3 is connected by a PCIe bus.

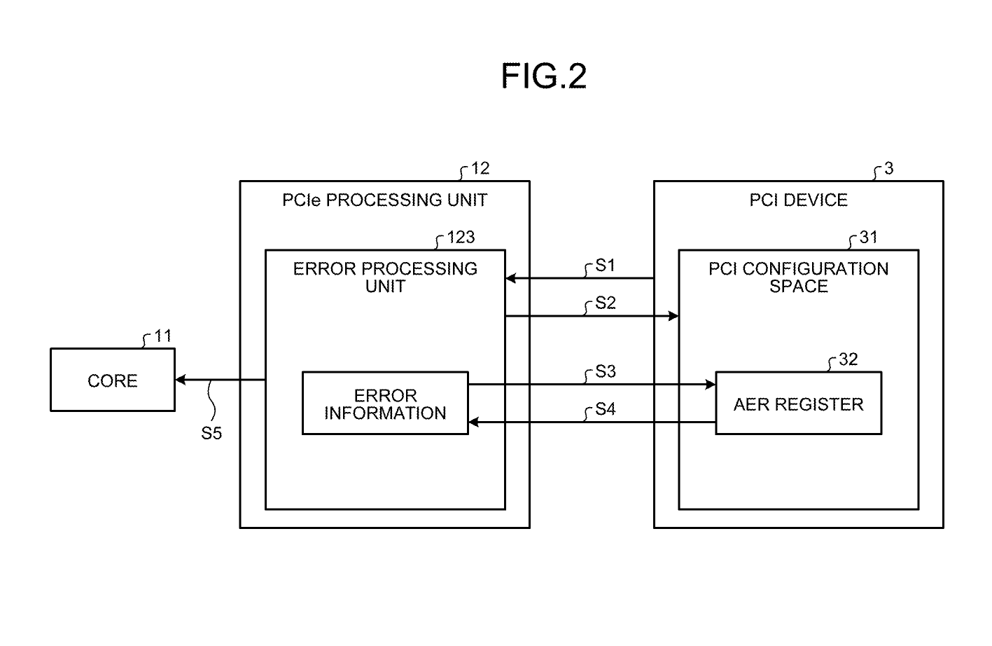

In the following, the error processing unit 123 will be described. First, the outline of an operation of the error processing unit 123 according to the first embodiment will be described with reference to FIG. 2. FIG. 2 is a schematic diagram illustrating, in outline, an operation of an error processing unit according to a first embodiment.

If an error occurs in the PCI device 3, the error processing unit 123 receives a Message from the PCI device 3 in which the error has occurred (Step S1).

Then, the error processing unit 123 acquires, from the received Message, the BDF that is the device location information on the PCI device 3 that is the transmission source. Then, the error processing unit 123 accesses, by using the BDF, the PCI device 3 in which the error has occurred. Then, the error processing unit 123 searches for the AER address of an AER register 32 in a PCI configuration space 31 in the PCI device 3 (Step S2).

Then, the error processing unit 123 sends, to the AER register 32, a transmission request for error information that includes therein the AER address (Step S3). Then, the error processing unit 123 acquires the error information that is related to the error and that is stored in the AER register 32 (Step S4). Thereafter, the error processing unit 123 sends the acquired error information to the core 11 (Step S5). At this point, if a plurality of errors occurs, the error processing unit 123 waits until the error processing unit 123 acquires error information on each of the errors and collectively sends the error information on each of the errors to the core 11.

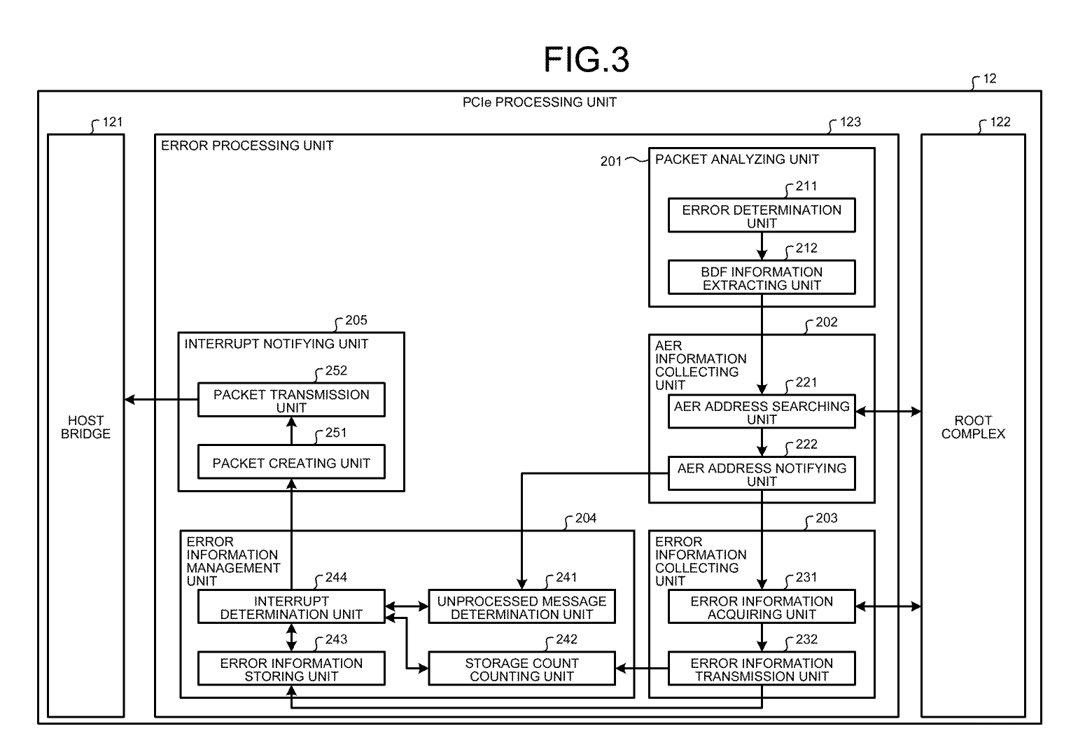

Furthermore, the error processing unit 123 will be described in detail with reference to FIG. 3. FIG. 3 is a block diagram illustrating, in detail, the error processing unit according to the first embodiment.

The error processing unit 123 includes a packet analyzing unit 201, an AER information collecting unit 202, an error information collecting unit 203, an error information management unit 204, and an interrupt notifying unit 205.

The packet analyzing unit 201 includes an error determination unit 211 and a BDF information extracting unit 212.

The error determination unit 211 receives, from the root complex 122, the Message that is output from the PCI device 3. In the Message, a requester identification (ID) indicating which device has sent the request, a message code, or the like is included. Then, the error determination unit 211 checks if the received packet is the Message from the message code. If the error determination unit 211 has checked that the received packet is the Message, the error determination unit 211 outputs the Message to the BDF information extracting unit 212.

The BDF information extracting unit 212 receives an input of the Message from the error determination unit 211. Then, the BDF information extracting unit 212 acquires, from the requester ID stored in the Message, the BDF of the PCI device 3 that is the output source of the Message. Then, the BDF information extracting unit 212 outputs the acquired BDF to an AER address searching unit 221 in the AER information collecting unit 202. The BDF information extracting unit 212 mentioned here corresponds to an example of a “specifying unit”.

The AER information collecting unit 202 includes the AER address searching unit 221 and an AER address notifying unit 222.

The AER address searching unit 221 receives, from the BDF information extracting unit 212, an input of the BDF of the PCI device 3 that is the output source of the Message. Then, the AER address searching unit 221 accesses the PCI device 3 by using the acquired BDF and searches for the AER address, in the PCI configuration space 31, of the PCI device 3 in which the error has occurred.

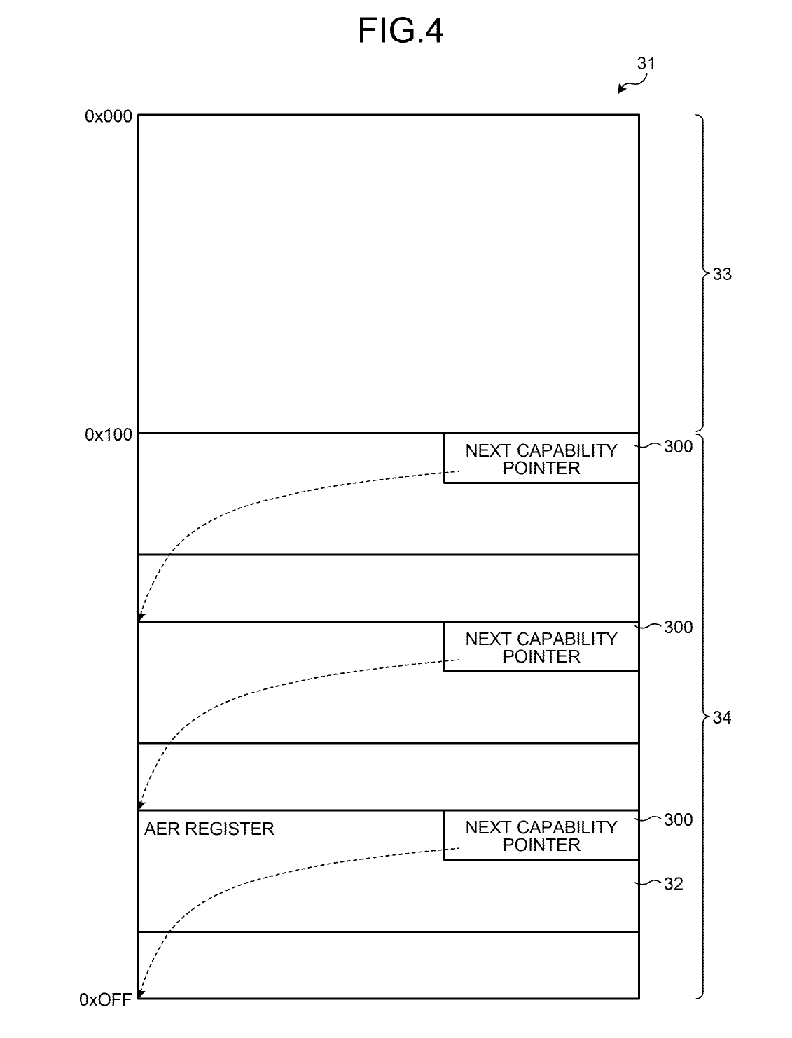

FIG. 4 is a schematic diagram illustrating a search method of an AER address. FIG. 4 represents the PCI configuration space 31. Furthermore, in FIG. 4, the numbers illustrated on the left side of the PCI configuration space 31 represent offset. The PCI configuration space 31 includes a PCI compatible configuration space 33 and a PCIe expansion configuration space 34.

The AER address searching unit 221 detects a device function register stored in the top in the PCIe expansion configuration space 34 in the PCI configuration space 31 in the PCI device 3 accessed by using the BDF. If the detected device function register is not the AER register 32, the AER address searching unit 221 checks a next capability pointer 300 held by the top device function register. The next capability pointer includes information indicating the address that indicates the subsequent device function register. Then, the AER address searching unit 221 detects the subsequent device function register indicated by the next capability pointer 300.

In this way, the AER address searching unit 221 searches the AER register 32 by sequentially detecting the device function registers from the top device function register by using the next capability pointer 300. Then, if the AER address searching unit 221 can specify the AER register 32 from this search, the AER address searching unit 221 acquires the AER address of the specified AER register 32. The AER address searching unit 221 outputs the acquired AER address to the AER address notifying unit 222 together with the BDF of the PCI device 3 in which the error has occurred. The AER address searching unit 221 mentioned here corresponds to an example of a “detecting unit”. Furthermore, the AER address mentioned here corresponds to an example of the “storage location”.

The AER address notifying unit 222 receives, from the AER address searching unit 221, an input of the AER address and the BDF of the PCI device 3 in which the error has occurred. Then, the AER address notifying unit 222 outputs the acquired AER address and the BDF to an error information acquiring unit 231 in the error information collecting unit 203. Furthermore, the AER address notifying unit 222 outputs, to an unprocessed message determination unit 241 in the error information management unit 204, a notification of an output of the AER address.

The error information collecting unit 203 includes the error information acquiring unit 231 and an error information transmission unit 232. The error information collecting unit 203 mentioned here corresponds to an example of a “collecting unit”.

The error information acquiring unit 231 receives, from the AER address notifying unit 222, an input of the AER address and the BDF of the PCI device 3 in which the error has occurred. Then, the error information acquiring unit 231 sends, by using the acquired BDF and the AER address, an acquisition request for the error information to the PCI device 3 in which the error has occurred. Then, the error information acquiring unit 231 acquires error information that is stored in the AER register 32 in the PCI configuration space 31 held by the PCI device 3 in which the error has occurred. Thereafter, the error information acquiring unit 231 outputs the acquired error information to the error information transmission unit 232.

The error information transmission unit 232 receives an input of the error information from the error information acquiring unit 231. Then, the error information transmission unit 232 outputs the acquired error information to an error information storing unit 243 in the error information management unit 204. Furthermore, the error information transmission unit 232 outputs a notification of the transmission of the error information to a storage count counting unit 242.

The error information storing unit 243 includes a storage medium, such as a memory or the like. In response to the input of the error information from the error information transmission unit 232, the error information storing unit 243 stores therein the acquired error information.

The storage count counting unit 242 includes a counter. When the storage count counting unit 242 receives the notification of the transmission of the error information from the error information transmission unit 232, the storage count counting unit 242 increments the counter by one. Then, by counting the number of times the storage count counting unit 242 receives the notification of the transmission of the error information, the storage count counting unit 242 counts the number of pieces of the error information stored in the error information storing unit 243.

When the storage count counting unit 242 receives the notification of the transmission of the error information from an interrupt determination unit 244, the storage count counting unit 242 resets the counter.

Furthermore, the storage count counting unit 242 previously stores a threshold of the amount of accumulated error information. Then, if the number of pieces of the error information stored in the error information storing unit 243, i.e., the value of the counter, exceeds the threshold, the storage count counting unit 242 sends a transmission instruction for the error information to the interrupt determination unit 244. Then, the storage count counting unit 242 resets the counter.

The unprocessed message determination unit 241 receives a notification of an output of the AER address from the AER address notifying unit 222. Then, the unprocessed message determination unit 241 determines whether the unprocessed message determination unit 241 has received the notification of the transmission of the error information from the interrupt determination unit 244 before the unprocessed message determination unit 241 receives the current notification after the unprocessed message determination unit 241 received the notification of the output of the immediately previous AER address.

If the unprocessed message determination unit 241 receives the notification of the transmission of the error information, the unprocessed message determination unit 241 sends, to the interrupt determination unit 244, a wait instruction that instructs to wait until the subsequent error information is stored. In contrast, if the unprocessed message determination unit 241 does not receive the notification of the transmission of the error information, the unprocessed message determination unit 241 determines that no unprocessed message is present and then waits.

The interrupt determination unit 244 monitors the error information storing unit 243. Then, the interrupt determination unit 244 determines whether error information is stored in the error information storing unit 243. If the error information is not stored, the interrupt determination unit 244 waits until the error information is stored in the error information storing unit 243.

In contrast, if the error information is stored in the error information storing unit 243, the interrupt determination unit 244 determines whether a transmission instruction for the error information has been received from the storage count counting unit 242. If the transmission instruction for the error information has not been received, the interrupt determination unit 244 determines whether the wait instruction has been received from the unprocessed message determination unit 241. If the wait instruction has been received, the interrupt determination unit 244 waits, without issuing an interrupt to the OS, until the subsequent error information is stored.

In contrast, if the transmission instruction for the error information has been received or if the transmission instruction of the error information has not been received and the wait instruction has not been received, the interrupt determination unit 244 determines to perform an interrupt. Then, the interrupt determination unit 244 acquires, from among pieces of the error information stored in the error information storing unit 243, the error information that has been determined to be stored and the error information that was stored before that and, furthermore, deletes the acquired error information from the error information storing unit 243. Then, the interrupt determination unit 244 issues an interrupt with respect to the OS and outputs the acquired error information to a packet creating unit 251 in the interrupt notifying unit 205.

Furthermore, the interrupt determination unit 244 notifies the transmission of the error information to an unprocessed message determination unit 241 and the storage count counting unit 242. The interrupt determination unit 244 mentioned here corresponds to an example of a “transmission unit”.

The interrupt notifying unit 205 includes the packet creating unit 251 and a packet transmission unit 252.

The packet creating unit 251 receives, from the interrupt determination unit 244, an input of one or plurality pieces of the error information and an execution instruction of an interrupt to the OS. Then, the packet creating unit 251 creates a packet that is used to notify the acquired error information. Then, the packet creating unit 251 sends the created packet and an instruction of an interrupt to the OS to the packet transmission unit 252.

The packet transmission unit 252 receives, from the packet creating unit 251, the packet that notifies the error information together with the instruction of the interrupt with respect to the OS. Then, the packet transmission unit 252 transmits the received packet to the core 11 via the host bridge 121 and performs the interrupt with respect to the OS.

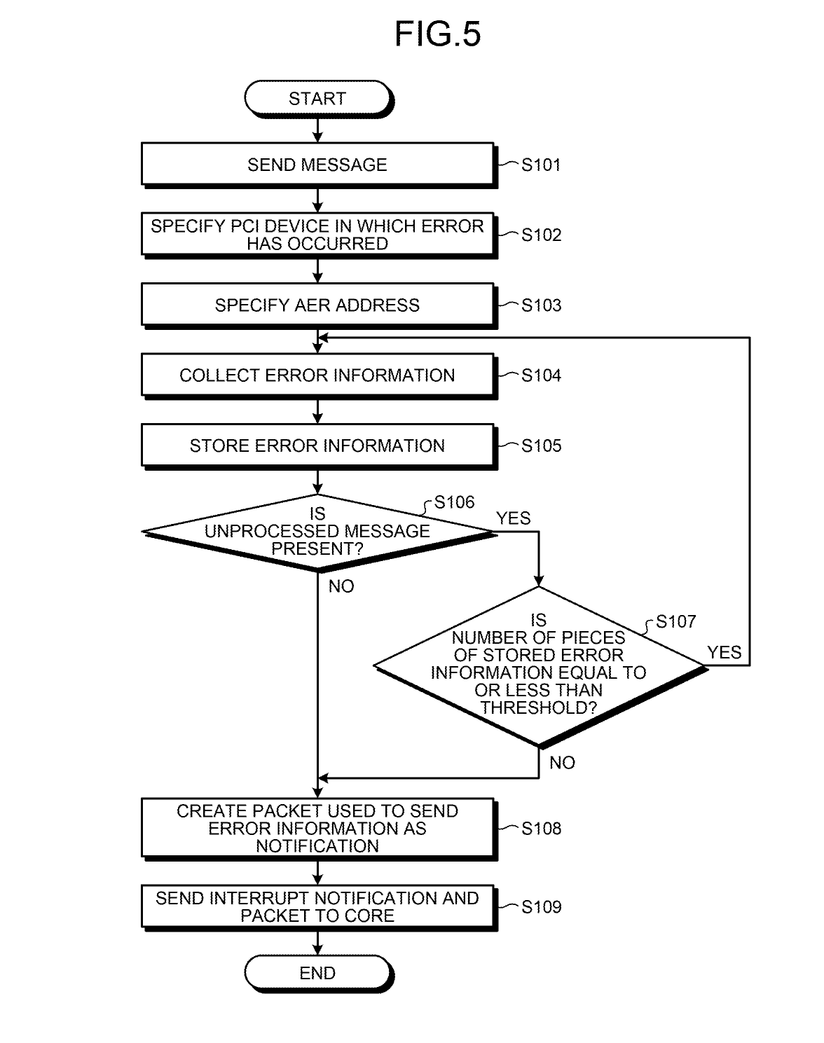

In the following, a notification process of the error information performed by the error processing unit 123 according to the first embodiment will be described with reference to FIG. 5. FIG. 5 is a flowchart illustrating the flow of a notification process of error information performed by the error processing unit according to the first embodiment.

The error determination unit 211 receives the Message sent from the PCI device 3 via the PCIe switch 2 and the root complex 122 (Step S101). The error determination unit 211 checks the received packet is the Message and then outputs the Message to the BDF information extracting unit 212.

The BDF information extracting unit 212 receives an input of the Message from the error determination unit 211. Then, the BDF information extracting unit 212 extracts the BDF from the request ID of the acquired Message and specifies the PCI device 3 in which the error has occurred (Step S102). Then, the BDF information extracting unit 212 outputs the extracted BDF to the AER address searching unit 221.

The AER address searching unit 221 receives an input of the BDF from the BDF information extracting unit 212. Then, the AER address searching unit 221 accesses, by using the acquired BDF, the PCI device 3 in which the error has occurred, searches for the AER address in the PCI device 3 in which the error has occurred (Step S103). The AER address searching unit 221 outputs the specified AER address to the AER address notifying unit 222 together with the BDF. The AER address notifying unit 222 receives an input of the AER address and the BDF from the AER address searching unit 221. Then, the AER address notifying unit 222 outputs the AER address and the BDF to the error information acquiring unit 231 and outputs the notification of the output of the AER address to the unprocessed message determination unit 241. If the unprocessed message determination unit 241 does not receive, from the interrupt determination unit 244, the notification of the transmission of the error information before the unprocessed message determination unit 241 receives the notification this time after having sent a notification of the output of the immediately previous AER address, the unprocessed message determination unit 241 outputs the wait instruction to the interrupt determination unit 244.

The error information acquiring unit 231 receives an input of the AER address and the BDF from the AER address notifying unit 222. Then, by using the acquired AER address and the BDF, the error information acquiring unit 231 collects the error information stored in the AER register 32 in the PCI device 3 in which the error has occurred (Step S104). The error information acquiring unit 231 outputs the collected error information to the error information transmission unit 232.

The error information transmission unit 232 receives an input of the error information from the error information acquiring unit 231. Then, the error information transmission unit 232 stores the acquired error information in the error information storing unit 243 (Step S105). Furthermore, the error information transmission unit 232 notifies the storage count counting unit 242 of the transmission of the error information and increments the counter of the storage count counting unit 242 by one. If the value of the counter exceeds the threshold, the storage count counting unit 242 sends a transmission instruction of the error information to the interrupt determination unit 244.

If the error information is stored in the error information storing unit 243, the interrupt determination unit 244 determines whether an unprocessed Message is present on the basis of the state in which an input of the wait instruction is received from the unprocessed message determination unit 241 (Step S106). If no unprocessed Message is present (No at Step S106), the interrupt determination proceeds to Step S108.

In contrast, if an unprocessed Message is received (Yes at Step S106), in accordance with whether the transmission instruction for the error information has been received from the storage count counting unit 242, the interrupt determination unit 244 determines whether the number of pieces of the error information stored in the error information storing unit 243 is equal to or less than the threshold (Step S107). If the number of pieces of the stored error information is equal to or less than the threshold (Yes at Step S107), the process returns to Step S104. Here, in FIG. 5, for convenience of explanation, the process performed at Step S104 and the subsequent steps are described as the processes subsequent to Steps S101 to S103; however, the processes performed at Steps S101 to S103 may also be performed independently of the processes performed at Step S104 and the subsequent steps.

If the number of pieces of the stored error information exceeds the threshold (No at Step S107), the interrupt determination unit 244 acquires the error information from the error information storing unit 243. Then, the interrupt determination unit 244 outputs the interrupt instruction and the error information to the packet creating unit 251.

The packet creating unit 251 receives an input of the interrupt instruction and the error information from the interrupt determination unit 244. Then, the packet creating unit 251 creates a packet that is used to send a notification of the error information (Step S108). Then, the packet creating unit 251 sends the created packet and an instruction of an interrupt with respect to the OS to the packet transmission unit 252.

The packet transmission unit 252 receives the packet used for the notification of the error information from the packet creating unit 251 together with the instruction of the interrupt to the OS. Then, the packet transmission unit 252 transmits, to the core 11 via the host bridge 121, the notification of the interrupt with respect to the OS together with the packet that notifies of the error information (Step S109).

As described above, if the PCIe processing unit according to the first embodiment receives the Message that is used for a notification of the occurrence of an error, the PCIe processing unit acquires the error information from the PCI device in which the error has occurred, sends the acquired error information to the OS, and performs an interrupt to the OS. Furthermore, the PCIe processing unit is implemented by hardware. Namely, because a search and acquisition of the error information are performed by the hardware, the OS that is software does not need to perform a process of searching for the error information in the PCI device and does not need to perform a process of acquiring the error information, which makes it possible to reduce the processing load applied to the core that operates the OS. Namely, it is possible to reduce the degradation of the throughput of the information processing apparatus.

Furthermore, with the PCIe processing unit according to the embodiment, if a plurality of errors continuously occurs, because error information related to the plurality of errors is collectively sent to the OS, it is possible to reduce the number of times an interrupt to the OS occurs and thus it is possible to reduce the processing load applied to the core that operates the OS.

### [b] Second Embodiment

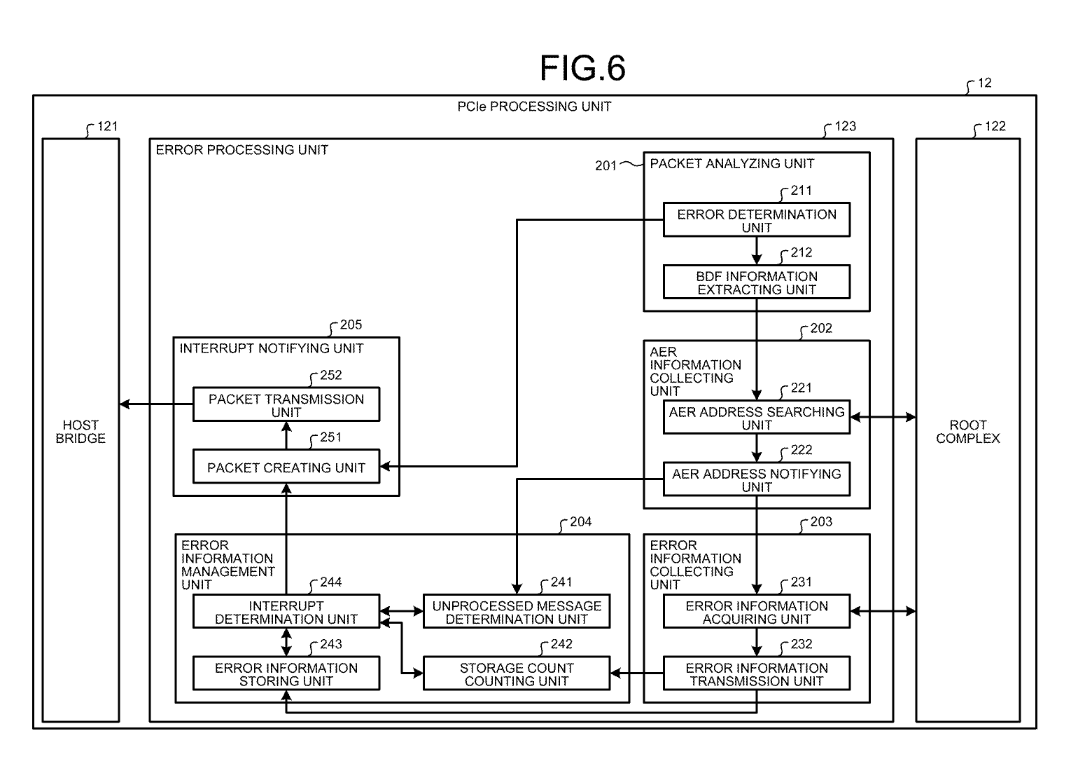

FIG. 6 is a block diagram illustrating, in detail, an error processing unit according to a second embodiment. The PCIe processing unit 12 according to the second embodiment differs from that described in the first embodiment in that, if the error that has occurred is a serious error, a process different from the process that is performed when an error is not serious is used in order to immediately send a notification to the OS. In a description below, components having the same function as those described in the first embodiment are assigned the same reference numerals; therefore, descriptions thereof will be omitted.

The error determination unit 211 receives the Message from the PCI device 3 in which an error has occurred via the PCIe switch 2 and the root complex 122. Then, the error determination unit 211 checks the message code of the Message and determines the error level of the error that has occurred, i.e., determines whether the error is a correctable error (CE) or an uncorrectable error (UE).

If the error that has occurred is a correctable error, because hardware can automatically correct the error and continue the process, the information processing apparatus can be continuously used without immediately sending a notification to the OS. Thus, if the error that has occurred is a correctable error, the error determination unit 211 sends the Message to the BDF information extracting unit 212 and allows the error processing unit 123 to acquire the error information and to notify the OS of the error information.

In contrast, if the error that has occurred is an uncorrectable error, because data is not able to be corrected, it is preferable to immediately send a notification to the OS. Thus, if the error that has occurred is an uncorrectable error, the error determination unit 211 directly sends the Message to the packet creating unit 251. Consequently, the search, the acquisition, and the notification of the error information with respect to this Message are not performed by the error processing unit 123. The error determination unit 211 mentioned here corresponds to an example of a “determination unit”.

The packet creating unit 251 receives an input of the Message from the error determination unit 211. Then, the packet creating unit 251 creates a packet that is used to send the Message. Thereafter, the packet creating unit 251 sends, to the packet transmission unit 252, the packet that is used to send the Message together with an instruction of an interrupt with respect to the OS.

The packet transmission unit 252 receives the packet that is used to send the error information as a notification from the packet creating unit 251 together with the instruction of the interrupt with respect to the OS. Then, the packet transmission unit 252 transmits an interrupt notification with respect to the OS to the core 11 via the host bridge 121 together with the packet that is used to send the Message as a notification.

The core 11 receives the interrupt notification with respect to the OS from the host bridge 121 together with the packet that is used to send the Message as a notification. Then, the core 11 performs an interrupt to the OS and allows the OS to search for and acquire the error information by using the received Message.

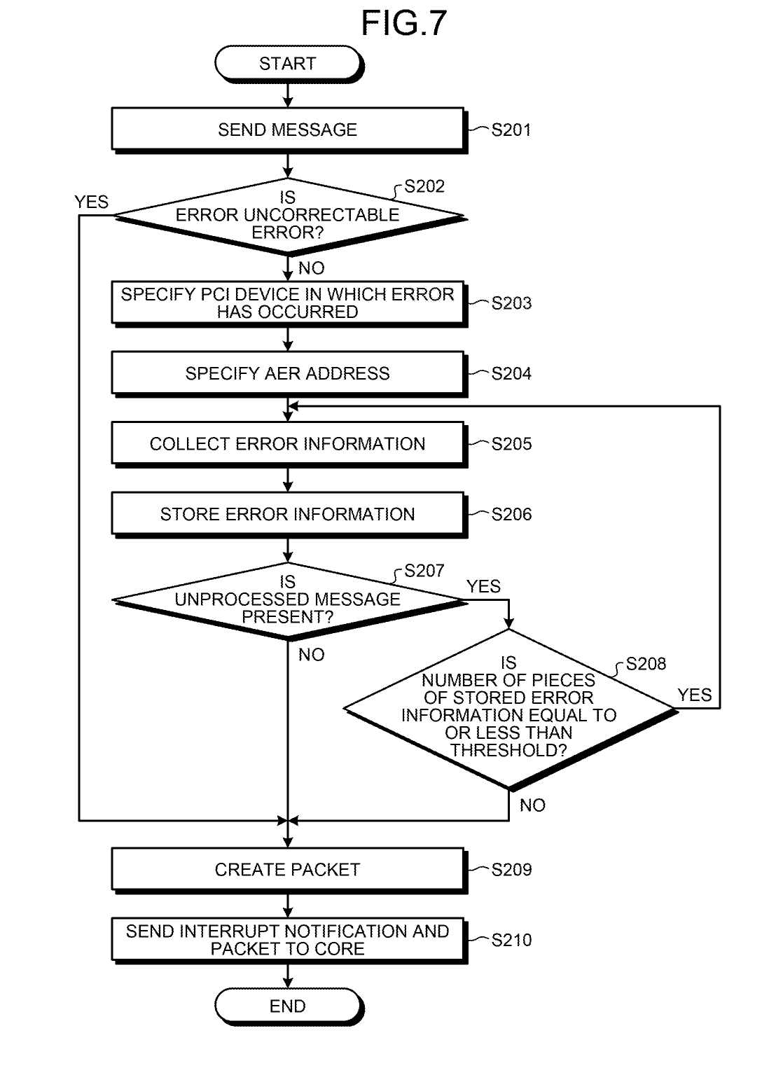

In the following, a notification process of the error information performed by the error processing unit 123 according to the second embodiment will be described with reference to FIG. 7. FIG. 7 is a flowchart illustrating the flow of a notification process of the error information performed by the error processing unit according to the second embodiment.

The error determination unit 211 receives, via the PCIe switch 2 and the root complex 122, the Message sent from the PCI device 3 (Step S201). The error determination unit 211 determines whether the error that has occurred is an uncorrectable error (Step S202).

If the error that has occurred is an uncorrectable error (Yes at Step S202), the error determination unit 211 sends the Message to the packet creating unit 251. Then, the process proceeds to Step S209.

In contrast, if the error that has occurred is a correctable error, i.e., is not an uncorrectable error (No at Step S202), the error determination unit 211 outputs the Message to the BDF information extracting unit 212.

The BDF information extracting unit 212 receives an input of the Message from the error determination unit 211. Then, the BDF information extracting unit 212 extracts the BDF from the request ID of the acquired Message and specifies the PCI device 3 in which the error has occurred (Step S203). Then, the BDF information extracting unit 212 outputs the extracted BDF to the AER address searching unit 221.

The AER address searching unit 221 receives an input of the BDF from the BDF information extracting unit 212. Then, by using the acquired BDF, the AER address searching unit 221 accesses the PCI device 3 in which the error has occurred, searches for the AER address in the PCI device 3 in which the error has occurred, and specifies the AER address (Step S204). The AER address searching unit 221 outputs the specified AER address to the AER address notifying unit 222 together with the BDF. The AER address notifying unit 222 receives an input of the AER address and the BDF from the AER address searching unit 221. Then, the AER address notifying unit 222 outputs the AER address and the BDF to the error information acquiring unit 231 and also outputs a notification of the output of the AER address to the unprocessed message determination unit 241. If the unprocessed message determination unit 241 does not receive a notification of the transmission of the error information from the interrupt determination unit 244 before the unprocessed message determination unit 241 receives the notification this time after having sent a notification of the output of the immediately previous AER address, the unprocessed message determination unit 241 outputs a wait instruction to the interrupt determination unit 244.

The error information acquiring unit 231 receives an input of the ER address and the BDF from the AER address notifying unit 222. Then, by using the acquired AER address and the BDF, the error information acquiring unit 231 collects the error information stored in the AER register 32 in the PCI device 3 in which the acquired error has occurred (Step S205). The error information acquiring unit 231 outputs the collected error information to the error information transmission unit 232.

The error information transmission unit 232 receives an input of the error information from the error information acquiring unit 231. Then, the error information transmission unit 232 stores the acquired error information in the error information storing unit 243 (Step S206). Furthermore, the error information transmission unit 232 notifies the storage count counting unit 242 of the transmission of the error information and increments the counter of the storage count counting unit 242 by one. If the value of the counter exceeds the threshold, the storage count counting unit 242 sends a transmission instruction of the error information to the interrupt determination unit 244.

If the error information is stored in the error information storing unit 243, the interrupt determination unit 244 determines whether an unprocessed Message is present in accordance with whether an input of the wait instruction is received from the unprocessed message determination unit 241 (Step S207). If no unprocessed Message is present (No at Step S207), the interrupt determination unit 244 proceeds to Step S209.

In contrast, if an unprocessed Message is received (Yes at Step S207), the interrupt determination unit 244 determines whether the number of pieces of the error information stored in the error information storing unit 243 is equal to or less than the threshold in accordance with whether the transmission instruction for the error information has been received from the storage count counting unit 242 (Step S208). If the number of pieces of the stored error information is equal to or less than the threshold (Yes at Step S208), the process returns to Step S205.

If the number of pieces of the stored error information exceeds the threshold (No at Step S208), the interrupt determination unit 244 acquires the error information from the error information storing unit 243. Then, the interrupt determination unit 244 outputs an interrupt instruction and the error information to the packet creating unit 251.

If the error that has occurred is a correctable error, the packet creating unit 251 receives an input of the interrupt instruction and the error information from the interrupt determination unit 244. Furthermore, if the error that has occurred is an uncorrectable error, the packet creating unit 251 receives an input of the Message from the error determination unit 211. Then, the packet creating unit 251 creates, by using the received information, a packet that is used for a notification of the error information or a packet that is used for a notification of the Message (Step S209). Thereafter, the packet creating unit 251 sends the created packet and an instruction of an interrupt with respect to the OS to the packet transmission unit 252.

The packet transmission unit 252 receives the packet from the packet creating unit 251 together with the instruction of the interrupt with respect to the OS. Then, the packet transmission unit 252 transmits the interrupt notification with respect to the OS together with the received packet to the core 11 via the host bridge 121 (Step S210).

Here, in the second embodiment, as the error level, the processes are separated into a process performed when an error is a correctable error and a process performed when an error is an uncorrectable error; however, the method of separating the error level is not limited to this. For example, in addition to an uncorrectable error, an error assumed to be a serious error is previously registered and, in also a case in which the serious error occurs, the error determination unit 211 may also directly send the Message to the packet creating unit 251.

As described above, if the error that has occurred is a serious error, the PCIe processing unit according to the second embodiment performs an interrupt due to the occurrence of the error with respect to the OS. Consequently, the OS can immediately be aware of the occurrence of the error and can promptly notify of an operator of the error or can promptly collect the error information. Thus, it is possible to implement a prompt response when a serious error occurs.

### [c] Third Embodiment

In the following, a third embodiment will be described. The PCIe processing unit according to the third embodiment differs from that described in the first embodiment in that the PCIe processing unit previously has an AER address of each of the PCI devices. In a description below, components having the same function as those described in the first embodiment are assigned the same reference numerals; therefore, descriptions thereof will be omitted.

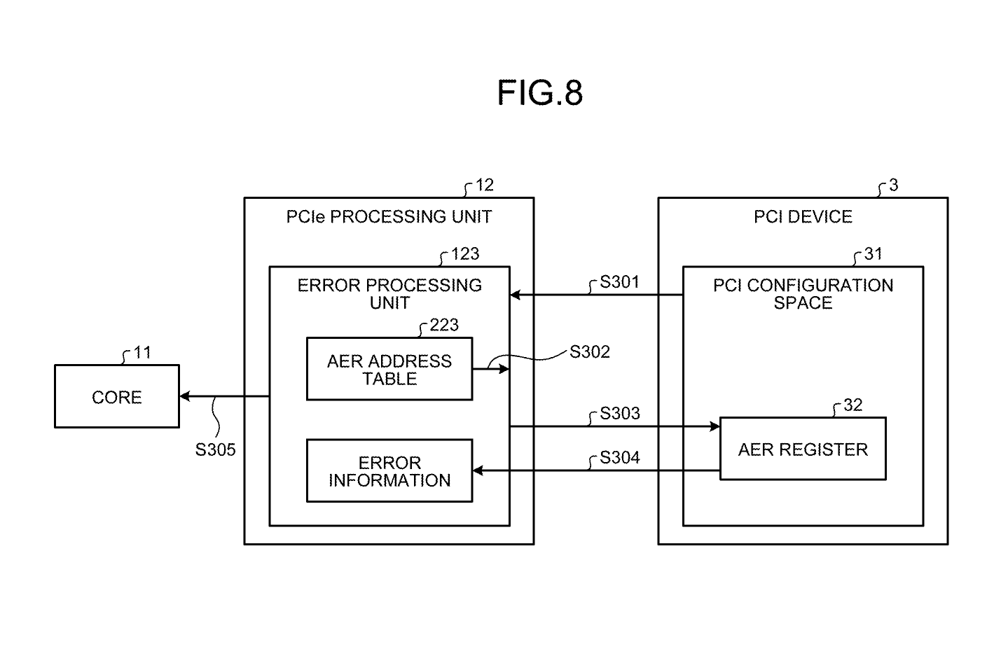

First, the outline of the operation of the error processing unit 123 according to the third embodiment will be described with reference to FIG. 8. FIG. 8 is a schematic diagram illustrating, in outline, an operation of an error processing unit according to a third embodiment.

As illustrated in FIG. 8, the error processing unit 123 according to the third embodiment previously has an AER address table 223. The AER address table 223 is a table in which the AER addresses of the PCI devices 3 are registered such that the AER addresses are associated with the identification information on the connected PCI devices 3.

In the following, a method of creating of the AER address table 223 will be described. The PCI devices 3 that are used by the information processing apparatus are substantially limited on the basis of the process performed by the information processing apparatus. Thus, an administrator can predict the number of the PCI devices 3 on the basis of the process performed by the information processing apparatus. Accordingly, for example, the administrator of the information processing apparatus predicts the extra number of the PCI devices 3 to be mounted. Then, the administrator stores the information on the predicted PCI devices 3 in an external storage, such as a read Only memory (ROM) or the like. Then, the core 11 operates the OS or firmware, thereby initializing the PCI devices 3 and acquires, at this time, the identification information on the PCI devices 3. Then, the core 11 acquires the information related to the identification information on the acquired PCI device 3 from the external storage and registers the information together with the BDF in the AER address table 223 included in the error processing unit 123.

In the following, the flow of a process performed by the error processing unit 123 will be described. If an error occurs in the PCI device 3, the error processing unit 123 receives the Message from the PCI device 3 in which the error has occurred (Step S301).

Then, the error processing unit 123 acquires, from the received Message, the BDF that is the device location information on the PCI device 3 that is the transmission source. Then, the error processing unit 123 acquires, from the AER address table 223 by using the BDF, the AER address of the PCI device 3 in which the error has occurred (Step S302).

Then, the error processing unit 123 sends a transmission request for the error information including the AER address to the AER register 32 (Step S303). Then, the error processing unit 123 acquires the error information related to the error that has occurred and that is stored in the AER register 32 (Step S304). Thereafter, the error processing unit 123 sends the acquired error information to the core 11 (Step S305). Here, if a plurality of errors occur, the error processing unit 123 waits until the error processing unit 123 acquires the error information on each of the errors and collectively sends the error information on each of the errors to the core 11.

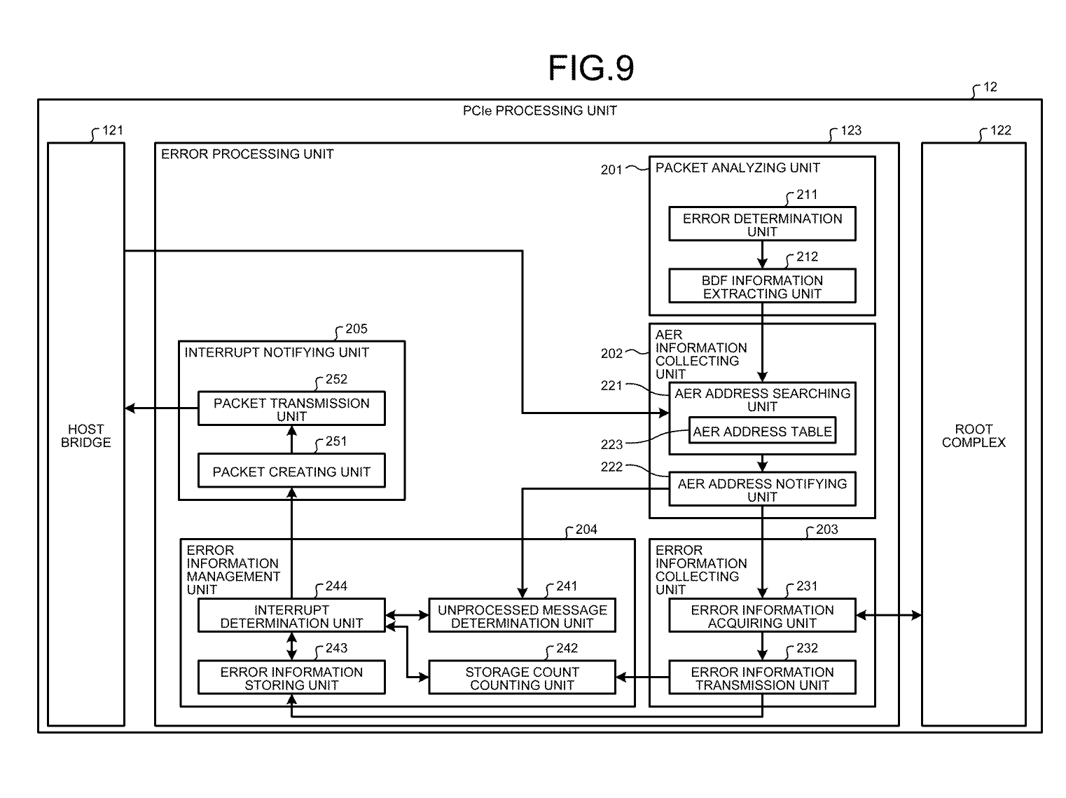

Furthermore, the error processing unit 123 will be described in detail with reference to FIG. 9. FIG. 9 is a block diagram illustrating, in detail, the error processing unit according to the third embodiment.

The AER address searching unit 221 includes the AER address table 223. The AER address searching unit 221 acquires, from the BDF information extracting unit 212, the BDF of the PCI device 3 in which an error has occurred. Then, the AER address searching unit 221 extracts the information on the PCI device 3 associated with the acquired BDF from the AER address table 223 and acquires the AER address of the PCI device 3.

Then, the AER address searching unit 221 outputs the AER address and the BDF of the PCI device 3 in which the error has occurred to the AER address notifying unit 222.

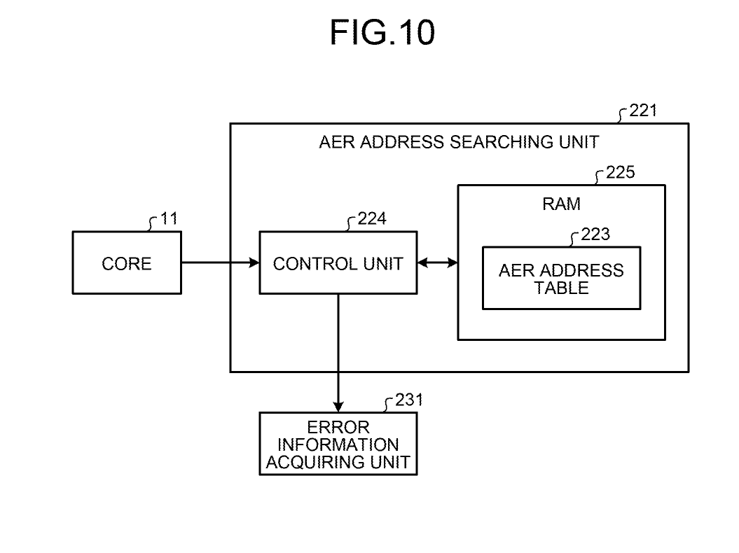

In the following, the registration and the acquisition of the AER address in the AER address table 223 will be further described in detail with reference to FIG. 10. FIG. 10 is a schematic diagram illustrating a process of registering and acquiring an AER address with respect to an AER address table.

The AER address searching unit 221 includes, more particularly, as illustrated in FIG. 10, a control unit 224 and a random access memory (RAM) 225. Furthermore, the AER address table 223 is stored in the RAM 225.

When an AER address is registered, the control unit 224 receives, from the core 11, the information that represents the association between the BDF and the AER address of the PCI device 3. Here, FIG. 10 illustrates a case in which information is directly sent from the core 11 to the control unit 224; however, in practice, the information is sent via the host bridge 121. Then, the control unit 224 sends a write enable signal to the RAM 225 and allows the RAM 225 to enter the state in which the information can be written. Thereafter, the control unit 224 registers the information that represents the association between the BDF and the AER address of the PCI device 3 in the AER address table 223 held by the RAM 225.

Furthermore, when the AER address is read, the control unit 224 sends a read enable signal to the RAM 225 and allows the RAM 225 to enter the state in which the information can be read. Thereafter, the control unit 224 reads, from the AER address table 223, the AER address associated with the BDF of the PCI device 3 in which an error has occurred.

As described above, the PCIe processing unit according to the third embodiment previously has the AER address table that represents the association between the BDF of each of the PCI devices that are connected and the AER address of each of the PCI device and acquires the AER address from the AER address table. Consequently, it is possible to eliminate the process of searching for the AER address in the PCI device in which the error has occurred and reduce the process performed to collect the error information by the PCIe processing unit. Thus, it is possible to further reduce the degradation of the performance of the information processing apparatus.

According to an aspect of an embodiment of the input/output control device, the information processing apparatus, and the control method of the input/output control device, an advantage is provided in that it is possible to reduce the degradation of the performance of the information processing apparatus.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An input/output control device connected to a processing unit, the input/output control device comprising:
a specifying unit that specifies, in response to an occurrence notification of an error, a processing unit in which the error has occurred;
a detecting unit that detects a storage location of error information related to the error held by the processing unit specified by the specifying unit;
a collecting unit that collects the error information from the storage location that is stored in the processing unit and that is detected by the detecting unit; and
a transmission unit that transmits the error information collected by the collecting unit to an arithmetic processing device.

2. The input/output control device according to claim 1, wherein, when the specifying unit receives an occurrence notification of another error before the transmission unit transmits the error information, the transmission unit waits until the error information related to the other error is collected by the collecting unit and collectively transmits all of the pieces of the collected error information to the arithmetic processing device.

3. The input/output control device according to claim 2, wherein, when the number of pieces of the error information collected by the collecting unit reaches a threshold in a standby time period of the transmission of the error information, the transmission unit transmits the error information collected by that time to the arithmetic processing device.

4. The input/output control device according to claim 1, wherein
the processing unit includes a storing unit that stores therein the error information, and
the detecting unit detects the address of the storage location of the error information stored in the storing unit.

5. The input/output control device according to claim 1, wherein
the storing unit stores therein a plurality of pieces of information including the error information and each of the pieces of the information include location information that indicates the location of subsequent information, and
the detecting unit detects, on the basis of the location information, the storage location of the error information by sequentially detecting the subsequent information from predetermined information that is included in the plurality of pieces of the information stored in the storing unit.

6. The input/output control device according to claim 1, wherein the detecting unit previously stores, at the time of start up, information on the storage location of the error information in the storing unit in the processing unit.

7. The input/output control device according to claim 1, further comprising a determination unit that determines, in response to the occurrence notification of the error, the level of the error that has occurred, that causes, when the error is a serious error, the transmission unit to send the occurrence notification of the error to the arithmetic processing device, and that transmits, when the error is not the serious error, the occurrence notification of the error to the detecting unit.

8. An information processing apparatus comprising:
an arithmetic processing unit;
a processing unit that performs a process in response to an instruction received from the arithmetic processing unit;
a switch that relays communication between the arithmetic processing unit and the processing unit;
a specifying unit that specifies, in response to an occurrence notification of an error, the processing unit in which the error has occurred;
a detecting unit that detects the storage location of error information related to the error held by the processing unit specified by the specifying unit;
a collecting unit that collects the error information from the storage location that is stored in the processing unit and that is detected by the detecting unit; and
a transmission unit that transmits the error information collected by the collecting unit to the arithmetic processing unit.

9. A control method of an input-output device connected to a processing unit, the control method comprising:
specifying, performed by a specifying unit included in the input-output device, in response to an occurrence notification of an error, a processing unit in which the error has occurred;
detecting, performed by a detecting unit included in the input-output device, the storage location of error information related to the error held by the processing unit specified by the specifying unit;
collecting, performed by a collecting unit included in the input-output device, the error information from the detected storage location stored in the processing unit; and
sending, performed by a transmission unit included in the input-output device, the collected error information to an arithmetic processing unit.
